(19) United States
(12) Patent Application Publication
(10) Pub. No.: US 2026/0115875 A1
(43) Pub. Date: Apr. 30, 2026

(54) POWER TOOL AND CLUTCH FOR A POWER TOOL

(71) Applicant: ATLAS COPCO INDUSTRIAL TECHNIQUE AB, Stockholm (SE)

(72) Inventors: Johan BJURKULL, Ingarö (SE); Guillermo BOSSI, Järfälla (SE); Shyam Geo PRAKASH, Salsjö-Duvnäs (SE)

(73) Assignee: ATLAS COPCO INDUSTRIAL TECHNIQUE AB, Stockholm (SE)

(21) Appl. No.: 19/160,609

(22) PCT Filed: Feb. 6, 2024
(86) PCT No.: PCT/EP2024/052893

§ 371 Date: Aug. 28, 2025

(30) Foreign Application Priority Data
Mar. 14, 2023 (SE) 2330124-5

(51) Int. Cl. B25B 23/14; B25B 23/147

(52) U.S. Cl. CPC B25B 23/141; B25B 23/147

(57) ABSTRACT

The present specification relates to a power tool comprising a motor, a clutch comprising a shaft and a preloaded spring element arranged around the shaft configured to control a clutch release torque and a torque setting mechanism for adjusting said clutch release torque of the clutch comprising an adjusting arrangement acting on the spring element and having first threads for cooperating with second threads provided on said shaft to adjust a deflection of said spring element upon relative rotation between the shaft and the adjusting arrangement, wherein the adjusting arrangement is arranged to be selectively locked from rotation such that a rotation of said output shaft and/or motor causes a change in spring deflection. The present specification also relates to a method for determining a clutch release torque and a control device configured to control such a power tool.

### TECHNICAL FIELD

The present invention generally relates to power tools, more particularly to power tools comprising clutches.

### TECHNICAL FIELD

Different types of power tools are known to be used in various industries, where one common type is tightening tools used for tightening of screws or bolts.

For example, so called clutch tools are known to be used where a clutch is arranged between the motor and the output to abort the tightening when a predetermined torque value is reached, this value is known as the clutch release torque value.

This clutch release torque value may be set in various ways. One known solution involves an elastic element, such as for example a spring element, arranged to control the clutch release value. To set the clutch the release value in such tools, the user may adjust the stiffness of the spring element.

Known solutions involve the user adjusting the spring length manually by means of for example a screw driver. Commonly, no feedback is provided to the user regarding the set torque values and it is hence difficult for the user to know to which release torque level the tool has been set and/or to get a feel for how much the torque has been adjusted.

Such setting of the clutch release torque value is therefore commonly only performed as part of a complicated calibration process before starting work and the tools must be calibrated at regular intervals in order to ensure that the torque applied by the tool (i.e. the clutch torque release value) is correct.

As an alternative, as the setting of the torque value is complex and time consuming, another common solution for applications were different torque levels need to be applied is to simply use several clutch tools calibrated to the different torque levels. This of course adds to costs and complexity of the work place.

Hence, there exists a need for improvements in the field of so called clutch tools, especially with regards to the setting of the clutch torque release value.

### SUMMARY OF THE INVENTION

Accordingly, it would be desirable to provide a clutch tool having an improved functionality with regards to setting and adjusting the clutch release torque. In particular, it would be desirable to provide a clutch tool having improved possibilities facilitating for a user to more precisely control the clutch release torque value. To better address one or more of these concerns a power tool, a method for determining a clutch release torque in such a power tool and a control device configured for controlling such a power tool as defined in the independent claims is provided. Preferred embodiments are defined in the dependent claims.

According to a first aspect of the invention a power tool for tightening of threaded fasteners is provided, the power tool comprising a motor, a clutch comprising a pressure plate configured to be rotatably driven by the motor, a cam follower plate, a shaft rotationally fixed relative to the cam follower plate, and a preloaded spring element arranged around the shaft and configured to press the cam follower plate against the pressure plate to control clutch release torque and a torque setting mechanism for adjusting the clutch release torque of the clutch comprising an adjusting arrangement acting on the spring element and having first threads for cooperating with second threads provided on the shaft to adjust a deflection of the spring element upon relative rotation between the shaft and the adjusting arrangement, wherein the adjusting arrangement is arranged to be selectively locked from rotation such that a rotation of the motor (and/or of the shaft) causes a change in spring deflection.

According to the first aspect, the clutch tool provides an inventive solution to the concerns described above by means of a design incorporating an adjusting arrangement co-operating with the shaft, whereby the user may adjust the spring deflection by effecting a relative rotation between the shaft and the arrangement by turning the motor (and/or the shaft). The skilled person realizes that a rotation of the shaft typically causes a rotation of the motor and vice versa.

As the adjusting arrangement may be locked in rotation, improved possibilities to conveniently and accurately control the clutch release torque are provided by means of the utilization of the motor for rotating the shaft instead of using manual tools.

The design therefore cleverly provides a clutch tool where the release torque may be more conveniently adjusted by a user, thereby providing improved control of the setting of the torque.

With regards to the power tool, according to one embodiment, the motor is an electric motor. The tool may for example be an electrically powered hand-held power tool. In some embodiments, the power tool may be a battery powered tool.

The spring element may be a coil spring, for example a compression coil spring and the deflection of the spring may also be referred to as spring travel.

According to one embodiment, the power tool further comprises a sensor arranged to sense a parameter from which a deflection of the spring can be derived.

According to one embodiment, the parameter is a parameter from which a rotation angle of the motor and/or the output shaft can be derived.

In one embodiment, the parameter is a parameter indicative of a rotational behavior of the motor and/or the output shaft. Such behavior may include for example angle, rotational speed or resistance to rotation.

According to one embodiment, the sensor is an angular sensor and the parameter is the rotation angle of the motor. This may be particularly advantageous in that the resolution provided may be very high, since a relatively small change in spring deflection (and hence clutch release torque value) normally requires a large number of rotations of the motor.

According to one embodiment, the power tool further comprises processing circuitry configured to determine a clutch release torque value based on the parameter.

The parameter, or parameter value, may for example first be converted to spring deflection, which in turns is converted in order to determine clutch release torque.

Alternatively, the parameter may be converted directly to clutch release torque.

The conversion may be made using a look-up table between the parameter and clutch release torque, or between the parameter and spring deflection. In the latter case, a further look-up table between spring deflection and clutch release torque may be used to determine the torque.

The look-up table(s) is/are predetermined and may be created in the design phase of the power tool.

Alternatively, the conversion may be made using at least one equation. The at least one equation may include an equation describing the relationship between spring deflection (displacement), or spring force, and clutch release torque, or between the parameter value and clutch release torque. Alternatively, two equations may be used: one between the parameter values and spring deflection or spring force, and one between spring deflection or force and clutch release torque.

The processing circuitry 90 may for example use any combination of one or more of a suitable central processing unit (CPU), multiprocessor, microcontroller, digital processor (DSP), application specific integrated circuit (ASIC), field programmable gate arrays (FPGA) etc.

According to one embodiment, the processing circuitry is further configured to determine the change in spring deflection caused by operation of the adjusting mechanism based on the parameter and a pre-set value indicative of a pitch of the first and second threads, and determine the clutch release torque value based on the determined change in spring deflection.

In some embodiments, the circuitry is configure to determine a change in clutch release value based on the above. For example, in one embodiment, if the number of rotations performed by the motor is known, a corresponding spring element deflection may be found from the number of rotations and the pitch, for example by estimation or calculation or by using known table values or similar. The corresponding change in spring force and hence the clutch release torque may then be determined from a known force-deflection ratio of the spring element, this ratio may also be referred to as the spring deflection ratio.

In one embodiment, the tool further comprises a gear assembly, and the processing circuitry is configured to determine the spring deflection based on the parameter, a pre-set value indicative of a pitch of the first and second threads and a known gear ratio of the gear assembly.

According to one embodiment, the processing circuitry is further configured to receive an input indicative of a desired clutch release torque value, and/or a desired change in clutch release value, and to control the motor to rotate when the adjusting mechanism is locked from rotation until the spring element is deflected to such an amount that achieves the desired clutch release torque value. The amount of deflection needed may in some embodiments be determined based on, or at least taking into consideration, a stored value of the current set torque value.

According to one embodiment, the circuitry is further configured to, prior to controlling the motor to rotate to achieve the desired deflection value, control the motor to rotate so as to arrive at a predetermined starting point. Hereby, a desired clutch release torque value may in some embodiments be set to an absolute value, based on the known starting point and the change to the clutch release torque effected by the deflection.

In one embodiment, the tool further comprises a trigger for controlling the motor to rotate in response to a trigger action, i.e. in response to the operator pressing the trigger.

In one embodiment, the trigger may be operated to effect a rotation of the motor in a first and a second direction and the circuitry is configured to, in response to an activation of the motor in the first (forward) direction increase the set clutch release torque value by a predetermined amount and in response to an activation of the tool in the second (reverse) direction decrease the clutch release value by the predetermined amount.

The circuitry may further, in some embodiment, be configured to for example, in response to trigger action, step between fixed torque values, the torque values may for example correspond to different bolt sizes, be mapped to different stations and/or positions etc.

In some embodiments, the circuity is further configured to selectively operate the motor in a setting mode where the motor is controlled to turn considerably slower than in normal operation mode for example in response to a user pressing a trigger.

In some embodiments, the power tool may further comprise a HMI allowing for a user to configure the tool. This could for example include inputting a desired clutch torque release value or setting the tool in the setting mode mentioned above. In one embodiment, the power tool is further configured to provide feedback for example on the present clutch torque release value to a user. In one embodiment, the power tool further comprises a display, and the circuitry is further configured to displaying information on screen for providing feedback. The information may include the set clutch torque value, a change to the clutch torque value etc.

According to one embodiment, the sensor is arranged to sense a motor current of the motor. The resistance of the spring element to deflection, and hence the motor current needed to turn the motor, is proportional to the length of the spring. The absolute value of the spring deflection and hence the absolute value of the clutch torque release value may therefore be estimated based on motor current data.

In one embodiment, the clutch tool comprises a first sensor arranged to sense a rotation angle of the motor and a second sensor arranged to sense a motor current. In such an embodiment the data from the current sensor may for example be used to provide an additional verification of the actual torque release clutch value. In one embodiment, a change in motor current may be used to verify that the adjustment arrangement has been locked in rotation.

According to one embodiment, the adjusting arrangement comprises an adjusting nut acting on the spring element to adjust a deflection of the spring element upon relative rotation between the output shaft and the adjusting nut.

According to one embodiment, the adjusting arrangement further comprises a supporting plate unit arranged adjacent the adjusting nut, and wherein the spring element bears against a plate shaped portion of the supporting plate unit. For example, one end of the spring element may bear against the plate and the other against the cam follower plate of the clutch.

According to one embodiment, the supporting plate unit further comprises an axially extending cylindrical portion on which the first thread is arranged. The first thread may be an inner thread arranged on an inner side of the cylindrical portion arranged to engage the second thread provided on the outside of the shaft.

According to one embodiment, the adjusting nut and the supporting plate unit comprise respective mutually cooperating locking means arranged to prevent relative rotation there between. In one embodiment, the locking means may allow for a relative axial movement while preventing relative rotation. This is advantageous in that the supporting plate unit may travel along with the spring as the deflection changes. In one embodiment, the locking means are formed by cooperating splines provided on the nut and adjusting plate unit respectively. The splines may be provided on the outer side of the cylindrical portion of the supporting plate unit.

According to one embodiment, the adjusting nut further comprises first engaging means arranged to lock a rotation of the adjustment nut. The engaging means may in one embodiment be formed by a hole provided in the adjustment nut allowing for a locking pin to be inserted. In some embodiments, the locking pin may be manually inserted by a user. In other embodiments, the tool may comprise an automatic locking pin assembly. The clutch tool may in some embodiments comprise a switch, mechanical or electrical, for effecting automatic locking of the adjustment nut.

According to one embodiment, the adjusting nut further comprises second engaging means for allowing manually turning of the adjustment nut in order to change the clutch release torque. Hereby, an additional possibility for manual adjustment is provided. In one embodiment, these engaging means may comprise teeth or similar structures with which e.g. a screwdriver may engage, such that a turning of the screw driver causes a manual turning of the nut. As the nut is turned with respect to the, in this case, stationary shaft, the deflecting of the spring will change

According to a second aspect of the present invention, a method for determining a clutch release torque in a power tool according to any one of the embodiments described in the foregoing is provided, the method comprising the steps of receiving data from which a deflection of the spring can be derived and determining a clutch release torque value based on the received data. Optionally, the method may further comprise storing and/or communicating the result of the determination of the clutch release torque.

The spring deflection may for example be derived and converted in order to determine clutch release torque. Alternatively, the data may be converted directly to clutch release torque. The conversion may be made using a look-up table between the data and clutch release torque, or between the data and spring deflection. In the latter case, a further look-up table between spring deflection and clutch release torque may be used to determine the torque. The look-up table(s) is/are predetermined and may be created in the design phase of the power tool.

Alternatively, the determining may be made using at least one equation. The at least one equation may include an equation describing the relationship between spring deflection (displacement), or spring force, and clutch release torque, or between the data and clutch release torque. Alternatively, two equations may be used: one between the data and spring deflection or spring force, and one between spring deflection or force and clutch release torque.

According to a third aspect of the present invention, a control device configured for controlling a power tool according to any one of the embodiments described in the foregoing is provided. The control device may comprise circuitry configured to execute the steps of the method according to the second aspect described above. The control device may be provided in the tool or it may be an external control device. The control device may further be arranged separately (and optionally remote) from the tool or it may be comprised within the tool. The control device may comprise a memory and processing means. The control device may e.g. be a computer. The control device may be comprised in a single unit or be distributed in several units (such as being cloud based).

Objectives, advantages and features of the method conceivable within the scope of the second and third aspect of the invention are readily understood by the foregoing discussion referring to the first aspect of the invention.

Further objectives of, features of and advantages of the present invention will become apparent when studying the following detailed disclosure, the drawings and the appended claims. Those skilled in the art realize that different features of the present invention can be combined to create embodiments other than those described in the following.

### BRIEF DESCRIPTION OF THE DRAWINGS

The invention will be described in the following illustrative and non-limiting detailed description of exemplary embodiments, with reference to the appended drawing, on which

FIG. 1 is a side view showing some of the components of an exemplary power tool according to one embodiment.

FIG. 2 is a perspective view of some of the components of an exemplary power tool according to one embodiment.

FIG. 3 is a side view of the tool housing of an exemplary power tool according to one embodiment.

FIG. 4 shows a method according to one embodiment.

All figures are schematic, not necessarily to scale and generally only show parts which are necessary in order to elucidate the invention, wherein other parts may be omitted or merely suggested.

### DETAILED DESCRIPTION

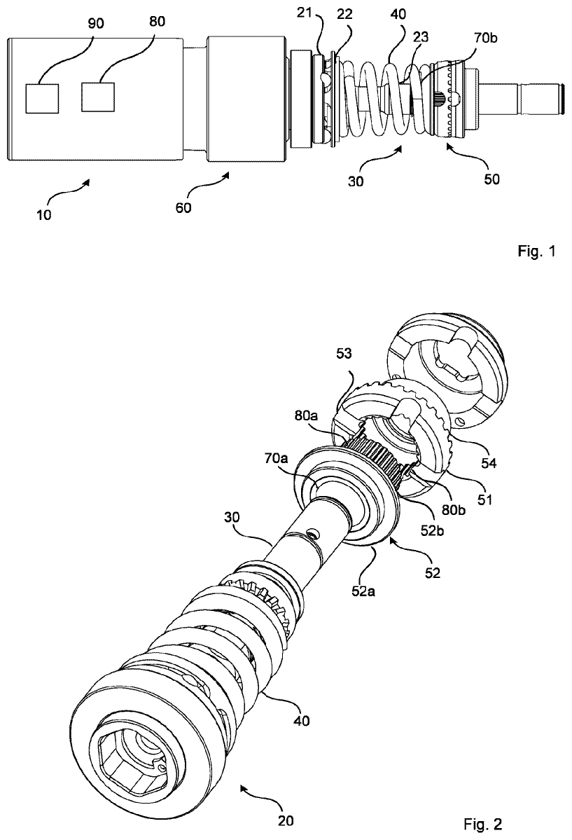

FIG. 1 is a side view of a portion of an exemplary power tool according to one embodiment showing some of the internal components of the tool, more particularly what may be referred to as the driveline.

A motor 10 is connected to a clutch 20 via a gear assembly The clutch 20 comprises a pressure plate 21 which is driven by the motor, a cam follower plate 22 to which a shaft 23 is attached and a spring 40 arranged around the shaft 23. The spring 40 is arranged to press the cam follower plate against the pressure plate, in order to control the value of the clutch release torque.

More particularly, the spring 40 pushes the cam follower plate 22 against the pressure plate 21 which thereby engage such that the rotation of the pressure plate 21 is transferred to the shaft 23. The clutch release torque, i.e. the torque required to release the clutch, is controlled by setting the spring 40 in a compressed state from which further compression causes the clutch to release (i.e. at the clutch release torque)-i.e. by adjusting the deflection of the spring as will be further explained in the following/below.

In the exemplary illustrated embodiment, balls 24 are arranged between the plates 21, 22 which prevent relative rotation between the two plates 21, 22 as long as the torque is smaller than the clutch torque release value. The cam follower plate 22 has cam surfaces 22a configured to cooperate with the balls 24. As a nut, bolt or screw is tightened by the rotation of the output shaft 23 the torque eventually increases to the clutch release torque level. The clutch is released when the cam follower plate 22 and the pressure plate 21 disengage, allowing the pressure plate 21 to rotate freely. The cam follower plate 22 is thus not driven by the pressure plate 21 when the clutch has released. Other types of cam follower mechanisms which do not use balls are also envisaged, as would be apparent to the skilled person.

The power tool further comprises a torque setting mechanism 30 for adjusting the clutch release torque of the clutch. The mechanism 30 comprising an adjusting arrangement 50 acting on the spring 40 to adjust the deflection, or compressed state, of the spring element upon relative rotation between the shaft and the adjusting arrangement.

The deflection is adjustable in the illustrated embodiment by means of an adjusting nut 51 and a supporting plate unit 52 arranged adjacent the adjusting nut acting on the spring element which bears against a plate shaped portion 52a of the supporting plate unit. An axial movement of plate unit 52 hence effects a change to the deflection of the spring 40.

To effect an adjustment of the axial position of the adjusting arrangement 50 upon relative rotation with respect to the shaft 23, the shaft 23 and the adjusting arrangement 50 are provided with mutually cooperating threads 70a, 70b. To this end, the supporting plate unit comprises an axially extending cylindrical portion 52b, where the first thread 70a is arranged on an inner side of the cylindrical portion. The second thread 70b with which the first threads 70a cooperate are provided on the outside of the shaft 23.

The shaft 23 may be conveniently rotated either by means of the motor or by means of manually rotating the output shaft of the tool (which in connected to the shaft 23), the skilled person realizes that a rotation of the shaft typically causes a rotation of the motor and vice versa.

The rotation of the adjusting arrangement 50 may in the illustrated embodiment be selectively locked in order to effect the relative rotation which in turn causes the deflection of the spring 40 to change as the shaft and/or motor is rotated. For this purpose, four holes 53 are provided in the adjusting nut 51, equally spaced along the circumference, to allow for a locking pin or similar to be inserted into one of the holes to stop any rotation of the nut 51 and in order to provide a rotational locking between the adjusting nut and the supporting plate unit, both components comprise splines 80a, 80b arranged to prevent relative rotation, (but allowing for an axial movement of the supporting plate unit 52 with respect to the nut 51 as the spring deflection changes).

In order to also allow for manual adjustment, the adjusting nut 51 of the illustrated embodiment however further comprises second engaging means in the form of teeth 54 with which e.g. a screwdriver may engage a for effecting a manual turning of the adjustment nut. In such an operating case, the shaft 23 is stationary such that the relative rotation between the adjusting arrangement 50 and the shaft 23, and thus the spring deflection, is achieved in what may be described as an opposite manner to the operating case described above.

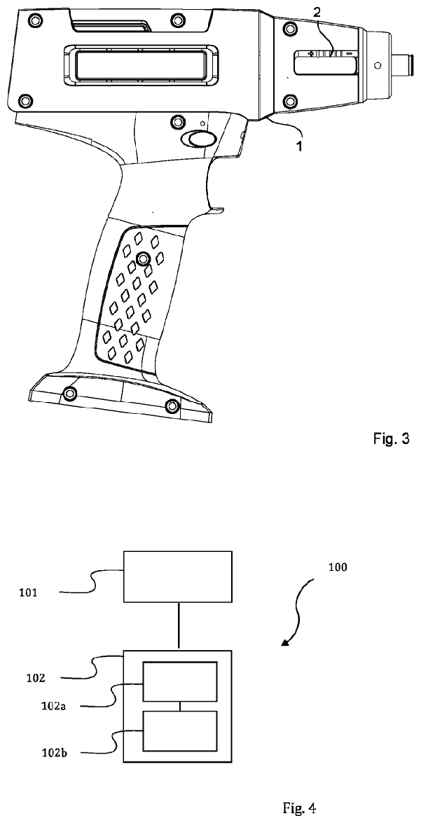

As may be seen from FIG. 3, the housing of the tool in the illustrated embodiment comprises an opening 2 provided at the front end, in a portion of the housing adjacent the adjusting arrangement 50, and arranged to allow for either a locking pin (or similar) to be inserted into the hole 53 or a screwdriver or similar for manual adjustment to be inserted to engage the teeth 54. In order to aid a user utilizing the manual mode, the housing in the embodiment illustrated in FIG. 3 comprises markings (+/−) indicating the direction for increasing and decreasing the clutch release torque.

In order to determine the torque clutch release value, the power tool may further comprise a sensor arranged to sense a parameter from which the deflection of the spring 40 can be derived.

As the deflection, as explained above, given that the adjusting mechanism is locked from rotating may be controlled by means of a rotation of the motor, one example of such a parameter is a parameter from which a rotation angle of said motor and/or said output shaft can be derived. In the illustrated embodiment, an angular sensor 80, such as an encoder, is arranged to sense a rotational angle of the motor.

The embodiment of FIG. 1 further comprises processing circuitry 90 configured to determine the clutch release torque value based on this parameter. This for example by determining the change in spring deflection caused by operation of the adjusting mechanism, based on the parameter and a pre-set value indicative of a pitch of the first and second threads, and determining the resulting clutch release torque value, or change in torque value, based on the determined change in spring deflection.

Based on a known number of turns made by the motor as sensed by the angular sensor, which may be converted into a known number of turns of the shaft 23 and knowing the gear ratio of the gear assembly 60, the deflection of the spring 40 may be obtained using the known thread pitch of the threads provided on the shaft. Using the known spring deflection ratio, the resulting spring force and thus clutch release torque value may in turn be obtained.

The processing circuitry may further optionally be configured to control the motor in order to achieve a desired change in clutch release torque or a desired clutch release torque value. This by, when the adjusting mechanism is locked, rotating the motor to reach a desired change in spring deflection, possibly starting from a predetermined starting point.

A method 100 according to an embodiment will now be described with reference to FIG. 4. The method 100 may e.g. be performed by the processing circuitry 90 described above and/or by a control device, possibly an external control device.

The method 100 may comprise a step 101 of receiving data from which a deflection of said spring can be derived.

The method 100 further comprises a step 102 of determining a clutch release torque value based on the received data. This step 102 may comprise a first step 102a of determining the change in spring deflection based on said data and a pre-set value indicative of a pitch of said first and second threads, and a second step 102b determining said clutch release value based on said determined spring deflection and a known spring deflection ratio.

While the invention has been illustrated and described in detail in the drawings and foregoing description, such illustration and description are to be considered illustrative or exemplary and not restrictive; the invention is not limited to the disclosed embodiment. The skilled person understands that many modifications, variations and alterations are conceivable within the scope as defined in the appended claims. Additionally, variations to the disclosed embodiments can be understood and effected by those skilled in the art in practicing the claimed invention, form a study of the drawings, the disclosure and the appended claims. In the claims, the word “comprising” does not exclude other elements or steps and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope of the claims.

1-16. (canceled)

17. A power tool for tightening of threaded fasteners, said tool comprising:
a motor;
a clutch comprising:
a pressure plate configured to be rotatably driven by the motor;
a cam follower plate;
a shaft rotationally fixed relative to the cam follower plate; and
a preloaded spring element arranged around the shaft and configured to press the cam follower plate against the pressure plate to control clutch release torque;
a torque setting mechanism for adjusting said clutch release torque of the clutch, the torque setting mechanism comprising an adjusting arrangement acting on the spring element and having first threads for cooperating with second threads provided on said shaft to adjust a deflection of said spring element upon relative rotation between the shaft and the adjusting arrangement, wherein the adjusting arrangement is arranged to be selectively locked from rotation such that a rotation of said shaft and/or motor causes a change in spring deflection; and
a sensor arranged to sense a parameter from which a deflection of said spring can be derived and wherein the parameter is a parameter from which a rotation angle of said motor and/or said output shaft can be derived.

18. A power tool according to claim 17, wherein the sensor is an angular sensor and said parameter is a rotation angle of the motor.

19. A power tool according to claim 17, wherein said sensor is a sensor arranged to sense a motor current of said motor.

20. A power tool according to claim 17, further comprising processing circuitry configured to determine a clutch release torque value based on said parameter.

21. A power tool according to claim 20, the processing circuitry being further configured to:
determine the change in spring deflection caused by operation of said adjusting mechanism based on said parameter and a pre-set value indicative of a pitch of said first and second threads; and
determining the clutch release torque value based on said determined change in spring deflection.

22. A power tool according to claim 20, wherein said processing circuitry is further configured to:
receive an input indicative of a desired clutch release torque value; and
control the motor to rotate when the adjusting mechanism is locked from rotation until the spring element is deflected to such an amount that achieves the desired clutch release torque value.

23. A power tool according to claim 22, wherein said processing circuitry is further configured to, prior to controlling the motor to rotate to achieve said desired deflection value, control the motor to rotate so as to arrive at a predetermined starting point.

24. A power tool according to claim 17, wherein the adjusting arrangement comprises an adjusting nut acting on the spring element to adjust a deflection of said spring element upon relative rotation between the shaft and the adjusting nut.

25. A power tool according to claim 24, wherein the adjusting arrangement further comprises a supporting plate unit arranged adjacent said adjusting nut, and wherein one end of the spring element bears against a plate shaped portion of said supporting plate unit.

26. A power tool according to claim 25, wherein said supporting plate unit further comprises an axially extending cylindrical portion on which said first thread is arranged.

27. A power tool according to claim 25, wherein the adjusting nut and said supporting plate unit comprise respective mutually cooperating locking means arranged to prevent relative rotation there between.

28. A power tool according to claim 24, wherein the adjusting nut further comprises first engaging means arranged to lock a rotation of said adjustment nut.

29. A method for determining a clutch release torque in a power tool used for tightening of threaded fasteners, said power tool comprising:
a motor;
a clutch comprising:
a pressure plate configured to be rotatably driven by the motor;
a cam follower plate;
a shaft rotationally fixed relative to the cam follower plate; and
a preloaded spring element arranged around the shaft and configured to press the cam follower plate against the pressure plate to control clutch release torque;
a torque setting mechanism for adjusting said clutch release torque of the clutch, the torque setting mechanism comprising an adjusting arrangement acting on the spring element and having first threads for cooperating with second threads provided on said shaft to adjust a deflection of said spring element upon relative rotation between the shaft and the adjusting arrangement, wherein the adjusting arrangement is arranged to be selectively locked from rotation such that a rotation of said shaft and/or motor causes a change in spring deflection; and
a sensor arranged to sense a parameter from which a deflection of said spring can be derived and wherein the parameter is a parameter from which a rotation angle of said motor and/or said output shaft can be derived,
wherein the method comprises:
receiving data including a parameter from which a deflection of said spring can be derived; and
determining a clutch release torque value based on the received data.

30. A control device configured for controlling a power tool used for tightening of threaded fasteners, said power tool comprising:
a motor;
a clutch comprising:
a pressure plate configured to be rotatably driven by the motor;
a cam follower plate;
a shaft rotationally fixed relative to the cam follower plate; and
a preloaded spring element arranged around the shaft and configured to press the cam follower plate against the pressure plate to control clutch release torque;
a torque setting mechanism for adjusting said clutch release torque of the clutch, the torque setting mechanism comprising an adjusting arrangement acting on the spring element and having first threads for cooperating with second threads provided on said shaft to adjust a deflection of said spring element upon relative rotation between the shaft and the adjusting arrangement, wherein the adjusting arrangement is arranged to be selectively locked from rotation such that a rotation of said shaft and/or motor causes a change in spring deflection; and
a sensor arranged to sense a parameter from which a deflection of said spring can be derived and wherein the parameter is a parameter from which a rotation angle of said motor and/or said output shaft can be derived,
wherein said control device is configured for:
receiving data including a parameter from which a deflection of said spring can be derived; and
determining a clutch release torque value based on the received data.
